(19) United States
(12) Patent Application Publication
(10) Pub. No.: US 2023/0257207 A1
(43) Pub. Date: Aug. 17, 2023

(54) COMPACT AND PRECISE CONVEYOR FOR A MACHINE FOR RECYCLING SOLAR PANELS

(71) Applicant: CVC TECHNOLOGIES INC., Taichung (TW)

(72) Inventors: YU-TING HSIAO, Taichung (TW); WEI-HSUN LIN, Taichung (TW)

(21) Appl. No.: 17/673,762

(22) Filed: Feb. 16, 2022

(51) Int. Cl. B65G 35/06; B65G 47/91; B65G 41/00

(52) U.S. Cl. CPC B65G 35/06; B65G 41/00; B65G 47/91; B65G 2201/022

(57) ABSTRACT

A conveyor includes an operative platform and a crane. The crane includes two lateral frames, a crossbar, a longitudinal bar, two extensible elements, and a vacuum chuck. The lateral frames are supported on the operative platform. The crossbar is supported on the lateral frames. The crossbar is movable between a first position and a second position. The longitudinal bar is connected to the crossbar. The extensible elements are connected to the longitudinal bar. The vacuum chucks are respectively connected to the extensible elements. One of the vacuum chucks is located beyond an end of the operative platform and the other vacuum chuck is located above the operative platform when the crossbar is in the first position. One of the vacuum chucks is located above the operative platform and the other vacuum chuck is located beyond another end of the operative platform when the crossbar is in the second position.

### BACKGROUND OF INVENTION

### 1. Field of Invention

The present invention relates to a machine for recycling solar panels and, more particularly, to a compact and precise convey for a machine for recycling solar panels.

### 2. Related Prior Art

Referring to FIG. 5, a conventional photovoltaic module 10 includes a solar panel 41 supported by a frame 16. The frame 16 includes multiple corner elements 17 for connecting two longer bars 18 to two shorter bars 19. The frame 16 is preferably made of metal such as aluminum for example.

The solar panel 41 includes a solar-cell array 13. An upper side of the solar-cell array 13 is connected to a tempered glass panel 11 by an encapsulant-EVA layer 12. A lower side of the solar-cell array 13 is connected to a back sheet 15 via another encapsulant-EVA layer 14.

The life of the photovoltaic module 10 is about 20 years. Then, the photovoltaic module must to disposed of or recycled. In Taiwan for example, about one million and six hundred thousand tons of used photovoltaic modules are disposed. Only a small amount of used photovoltaic modules is recycled.

Taiwanese Patent No. I752572 discloses an apparatus for automatically dismantling photovoltaic modules. This conventional apparatus detaches the frame from the solar panel to recycle the valuable aluminum used to make the frame. Then, the solar panel is crushed so that useful materials can be recycled. Then, the remnants of the solar panel are burned at high temperature such as 600° C. so that pyrolysis occurs. The combustion of ethylene vinyl acetate (“EVA”) and polyvinylidene difluoride (“PVDF”) inevitably produces side products such as volatile organic compounds (“VOCs”), CO and silicon. The side products are not valuable or environmentally friendly.

Taiwanese Patent Application Publication No. 202031378 discloses a machine for recycling photovoltaic modules. This conventional machine includes a conveyor that includes a belt and pulleys. However, the use of belt and pulleys renders this conveyor bulky and unprecise.

The present invention is therefore intended to obviate or at least alleviate the problems encountered in the prior art.

### SUMMARY OF INVENTIO

It is the primary objective of the present invention to provide a recycling machine with a compact and precise conveyor.

To achieve the foregoing objective, the conveyor includes an operative platform and a crane. The crane includes two lateral frames, a crossbar, a longitudinal bar, an extensible element, and a vacuum chuck. The lateral frames are supported on the operative platform. The crossbar is supported on the lateral frames so that the crossbar spans the operative platform. The crossbar is movable to and fro on the lateral frames between a first position and a second position. The longitudinal bar is connected to the crossbar so that they are movable together. The extensible elements are connected to the longitudinal bar so that they are movable together. The vacuum chucks are respectively connected to the extensible elements so that the extensible elements are operable to move the vacuum chucks between a lower position and an upper position. One of the vacuum chucks is located beyond the first end of the operative platform and the remaining one of the vacuum chucks is located above the operative platform when the crossbar is in the first position. One of the vacuum chucks is located above the operative platform and the remaining one of the vacuum chucks is located beyond the second end of the operative platform when the crossbar is in the second position.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a conveyor according to the preferred embodiment of the present invention;

FIG. 2 is a perspective view of a driving unit of the conveyor shown in FIG. 1;

FIG. 3 is a top view of the conveyor shown in FIG. 1;

FIG. 4 is a front view of the conveyor shown in FIG. 1; and

FIG. 5 is an exploded view of a conventional photovoltaic module.

### DETAILED DESCRIPTION OF PREFERRED EMBODIMENT

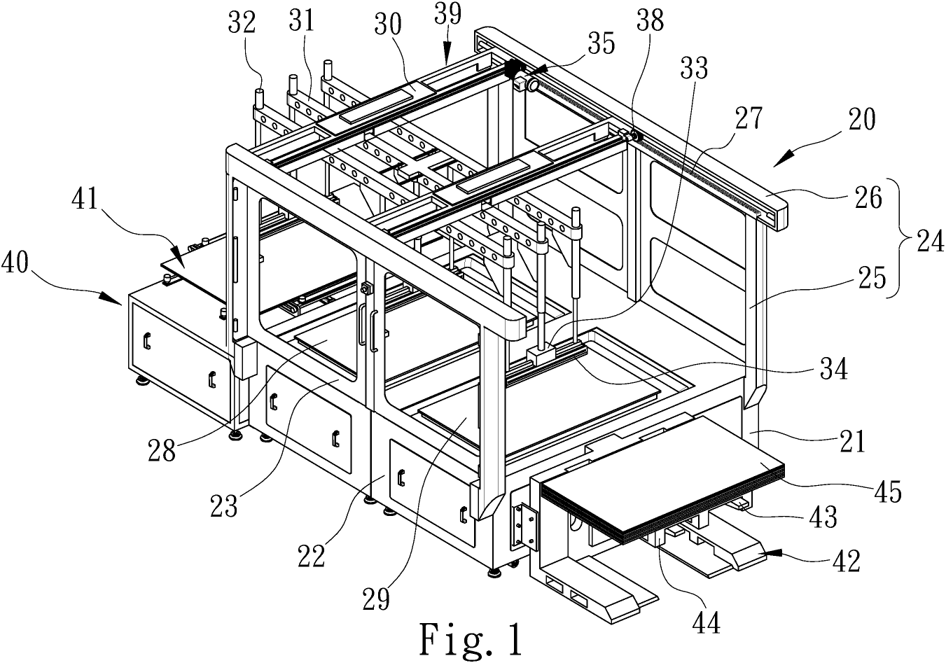

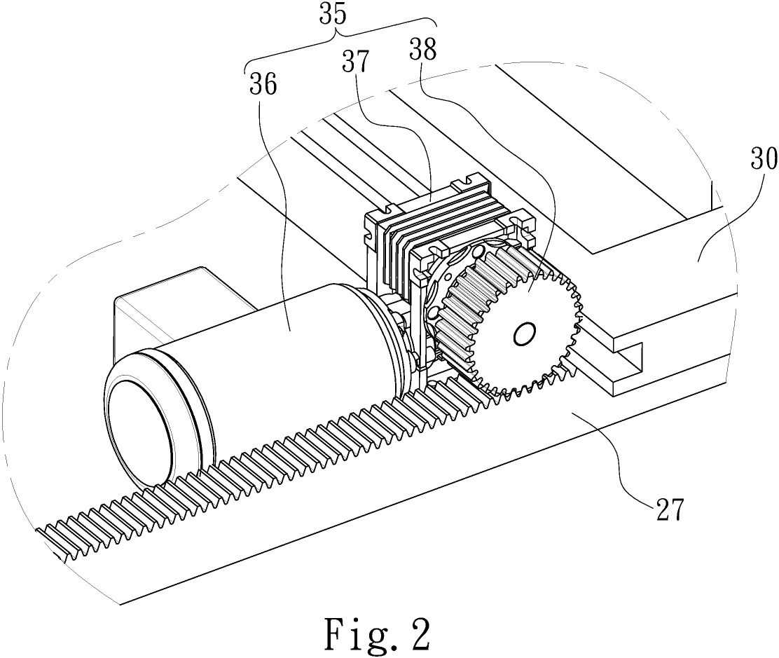

Referring to FIGS. 1 through 4, there is shown a conveyor 20 according to the preferred embodiment of the present invention. The conveyor 20 is used in a machine and process for recycling solar panels 41.

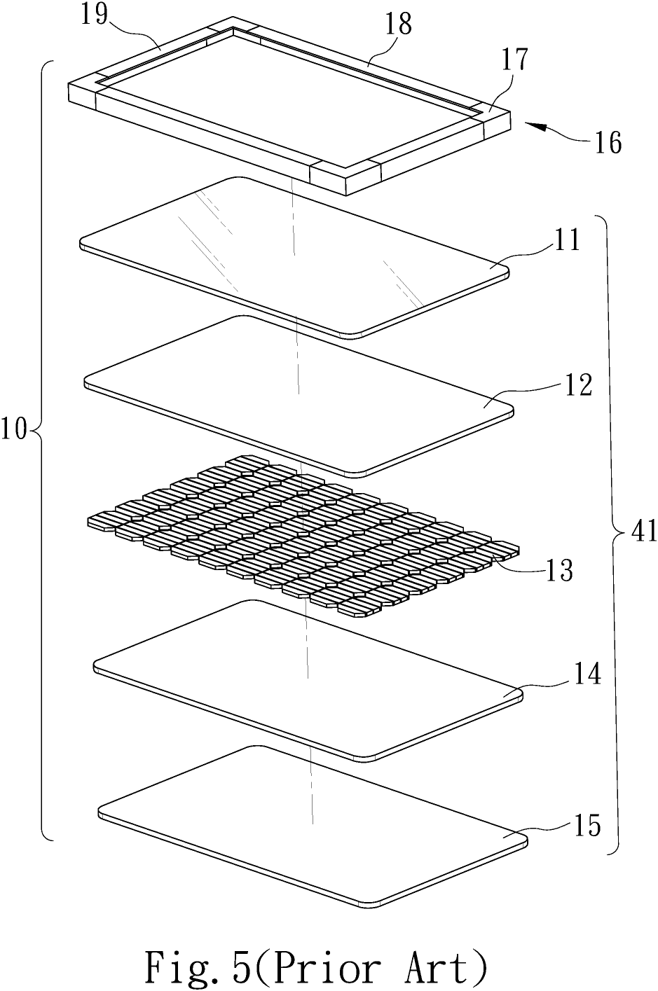

As described above in the RELATED PRIOR ART referring to FIG. 5, each of the solar panels 41 includes a solar-cell array 13, two encapsulant-EVA layers 12 and 14, a back sheet 15, and a glass panel 11. The recycling process includes two phases. In the first phase, at least the back sheet 15 is scratched. In the second phase, at least the encapsulant-EVA layer 12 is scratched. Anyway, the back sheet 15, the encapsulant-EVA layer 14, the solar-cell array 13 and the encapsulant-EVA layer 12 are scratched, leaving the glass panel 11 to be recycled. For briefness and clarity of the following description, a term, “laminate”, is used to describe what is left after the first phase of the recycling process is executed and before the second phase of the recycling process is executed.

Preferably, the conveyor 20 includes an operative platform 21, a crane 39, a pre-operation platform 40, and an elevator 42. The operative platform 21 is located between the pre-operation platform 40 and the elevator 42. Preferably, the operative platform 21, the pre-operation platform 40 and the elevator 42 are interconnected. The crane 39 is supported on the operative platform 21.

The operative platform 21 includes two interconnected operative zones 28 and 29. Each of the operative zones 28 and 29 includes an operative chamber above it, and a door panel 23 is preferably used to close each of the operative chambers. Preferably, each of the operative zones 28 and 29 includes a storage chamber below it, and a door panel 22 is used to close each of the storage compartments.

The pre-operation platform 40 is connected to the operative zone 28.

The elevator 42 is connected to the operative zone 29. The elevator 42 includes a fork 43 for carrying a pallet 44. The fork 43 is like a fork of a stacker.

Preferably, the crane 39 includes two lateral frames 24, two racks 27, four cogs 38, two crossbars 30, three longitudinal bars 31, nine extensible elements 32, nine connectors 33, three vacuum chucks 34, and a driving unit 35. In another embodiment, there can be another number of crossbars 30, another number of longitudinal bars 31, another number of extensible elements 32, and/or another number of connectors 33.

The lateral frames 24 are supported on the operative platform 21. Each of the lateral frames 24 includes two posts 25 and a beam 26. Each of the posts 25 includes a lower end connected to the operative platform 21 and an upper end connected to the beam 26.

Preferably, each of the door panels 23 is pivotally connected to one of the posts 25.

Each of the racks 27 is supported on one of the beams 26. Each of the racks 27 extends along one of the beams 26.

The crossbars 30 are supported on and movable along the beams 26. The crossbars 30 extend horizontally.

Each of the longitudinal bars 31 are connected to the crossbars 30 so that the longitudinal bars 31 are movable together with the crossbars 30. The longitudinal bars 31 extend horizontally.

Three of the extensible elements 32 along a longitudinal line are connected to each of the longitudinal bars 31 so that the extensible elements 32 are movable together with the longitudinal bars 31. The extensible elements 32 extend vertically.

Each of the connectors 33 is connected to one of the extensible elements 32 so that the connectors 33 are movable together with the extensible elements.

Each of the vacuum chucks 34 is connected to three of the connectors 33 along a transverse line so that the vacuum chucks 34 are movable together with the connectors 33. Each of the vacuum chucks 34 is an elongated element.

Each of the cogs 38 is connected to one of two ends of one of the crossbars 30. Each of the cogs 38 is engaged with one of the racks 27. Thus, the crossbars 30 are movable along the beams 26 when the cogs 38 is rolled along the racks 27.

The driving unit 35 includes a motor 36 and a reducer 37. Preferably, the motor 36 is supported on a selected one of the crossbars 30, and the reducer 37 is arranged between the motor 36 and one of the cogs 38 connected to the selected crossbar 30. Thus, the motor 36 is operable to rotate the cogs 38 via the reducer 37. In another embodiment, the reducer 37 can be omitted.

Although not shown, a controller equipped with a touch panel or a combination of a display with a keypad is preferably used to control the crane 39. The controller is used to run a software program with parameters to control the crane 39.

For clarity of the following description, the vacuum chucks 34 will be referred to as the “leading vacuum chuck 34”, the “last vacuum chuck 34” and the “middle vacuum chuck 34.”

In the beginning, no solar panel is supported on the operative zone 28 or 29 of the operative platform 21. The solar panels 41 are supported on the pre-operation platform 40.

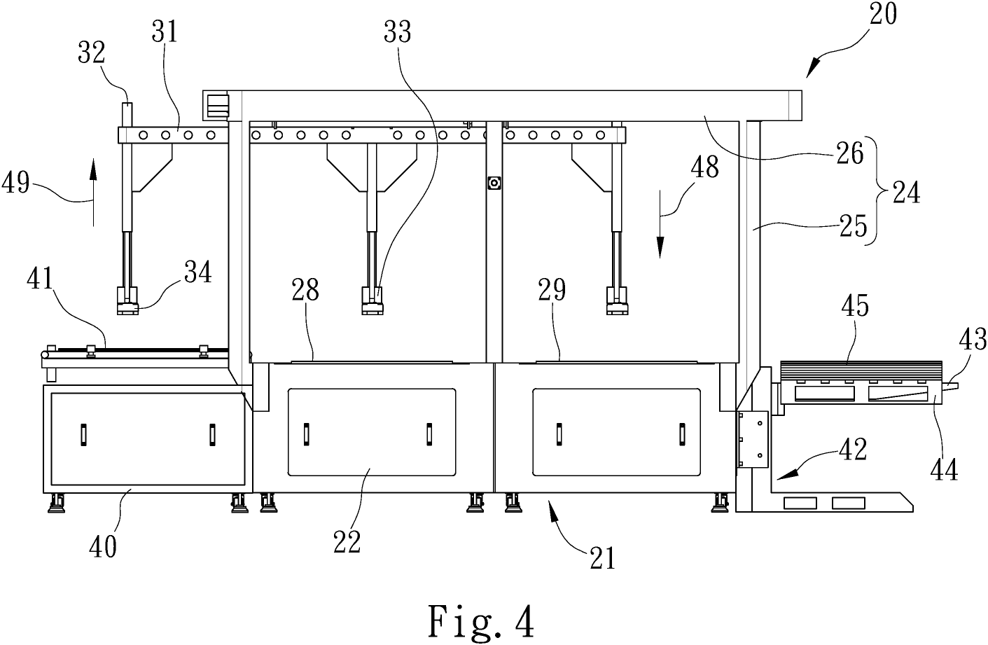

The crane 39 is located in a first position where the leading vacuum chuck 34 is located above the pre-operation platform 40, the middle vacuum chuck 34 is located above the operative zone 28, and the last vacuum chuck 34 is located above the operative zone 29. Then, the extensible elements 32 are actuated to lower the vacuum chucks 34 as indicated by an arrow head 48 (FIG. 4). Then, the vacuum chucks 34 are actuated so that the leading vacuum chuck 34 sucks a first solar panel 41 while the middle and last vacuum chucks 34 do not suck any solar panel. Then, the extensible elements 32 are actuated to lift the vacuum chucks 34 and the first solar panel 41 as indicated by an arrow head 49 (FIG. 4).

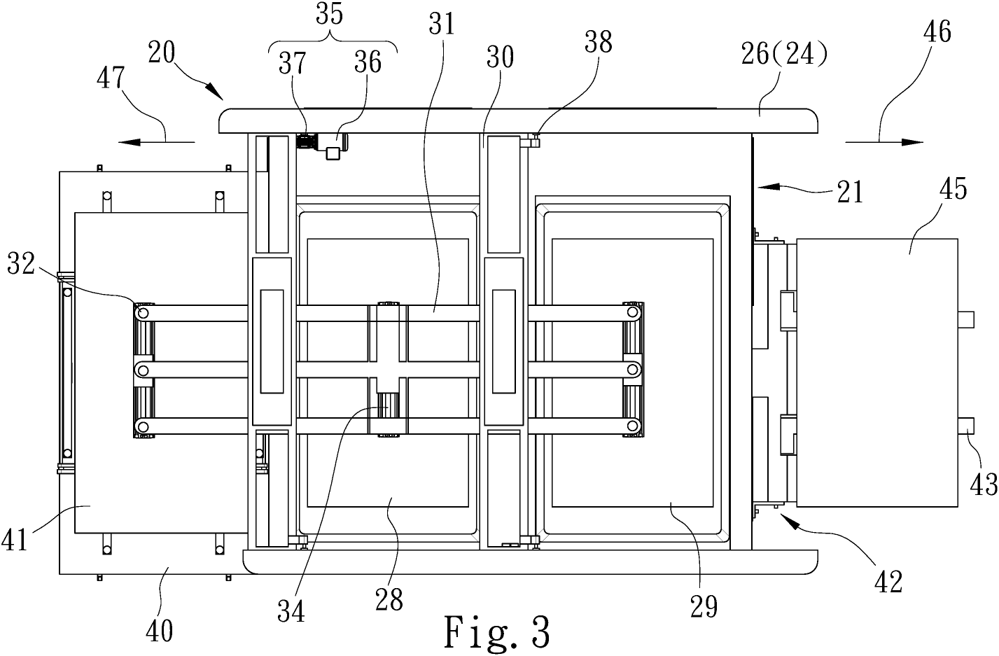

Then, as indicated by an arrow head 46 (FIG. 3), the driving unit 35 is actuated to move the crane 39 to a second position where the leading vacuum chuck 34 is located above the operative zone 28, the middle vacuum chuck 34 is located above the operative zone 29, and the last vacuum chuck 34 is located above the pallet 44, which is carried by the fork 43 of the elevator 42. Then, the extensible elements 32 are actuated to lower the vacuum chucks 34. Then, the vacuum chucks 34 are turned off to drop the first solar panel 41 onto the operative zone 28. Then, the extensible elements 32 are actuated to lift the vacuum chucks 34.

Now, the first solar panel 41 is left on the operative zone 28, and the other solar panels 41 are still supported on the pre-operation platform 40. There is no solar panel on the operative zone 29. In the operative zone 28, the first phase of the recycling is executed on the first solar panel 41 so that the first solar panel 41 is turned into a laminate.

Then, as indicated by an arrow head 47 (FIG. 3), the driving unit 35 is actuated to return the crane 39 to the first position. Then, the extensible elements 32 are actuated to lower the vacuum chucks 34. Then, the vacuum chucks 34 are actuated so that the leading vacuum chuck 34 sucks a second solar panel 41, the middle vacuum chuck 34 sucks the first solar panel 41, and the last vacuum chuck 34 does not suck any solar panel. Then, the extensible elements 32 are actuated to lift the vacuum chucks 34 and the first and second solar panels 41.

Then, the driving unit 35 is actuated to move the crane 39 to the second position. Then, the extensible elements 32 are actuated to lower the vacuum chucks 34. Then, the vacuum chucks 34 are turned off to drop the first solar panel 41 onto the operative zone 29 and drop the second solar panel 41 onto the operative zone 28. Then, the extensible elements 32 are actuated to lift the vacuum chucks 34.

Now, the first solar panel 41 is left on the operative zone 29, the second solar panel is left on the operative zone 28, and the other solar panels 41 are still supported on the pre-operation platform 40. In the operative zone 29, the second phase of the recycling process is executed on the laminate of the first solar panel 41 to turn it into a glass panel 45. In the operative zone 28, the second phase of the recycling process is executed on the second solar panel 41 to turn it into a laminate.

Then, the driving unit 35 is actuated to return the crane 39 to the first position. Then, the extensible elements 32 are actuated to lower the vacuum chucks 34. Then, the vacuum chucks 34 are actuated so that the leading vacuum chuck 34 sucks a third solar panel 41, the middle vacuum chuck 34 sucks the second solar panel 41, and the last vacuum chuck 34 sucks the first solar panel. Then, the extensible elements 32 are actuated to lift the vacuum chucks 34 and the first, second and third solar panels 41.

Then, the driving unit 35 is actuated to move the crane 39 to the second position. Then, the extensible elements 32 are actuated to lower the vacuum chucks 34. Then, the vacuum chucks 34 are turned off to drop the first solar panel 41 onto the pallet 44, drop the second solar panel 41 onto the operative zone 29, and drop the third solar panel 41 onto the operative zone 28. Then, the extensible elements 32 are actuated to lift the vacuum chucks 34.

Now, the glass panel 45 of the first solar panel 41 is left on the pallet 44, the laminate of the second solar panel 41 is left on the operative zone 29, and the third solar panel 41 is left on the operative zone 28. In the operative zone 29, the second phase of the recycling process is executed on the laminate of the second solar panel 41 to turn it into a glass panel 45. In the operative zone 28, the first phase of the recycling process is executed on the third solar panel 41 to turn it into a laminate.

The conveyor 20 repeats the foregoing process to move the solar panels 41 from the pre-operation platform 40 and move the glass panels 45 onto the pallet 44, which is carried by the fork 43 of the elevator 42.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A conveyor comprising an operative platform and a crane, wherein the operative platform comprises a first end and a second end, and wherein the crane comprises:
two lateral frames supported on the operative platform;
at least one crossbar supported on the lateral frames so that the crossbar spans the operative platform, wherein the crossbar is movable to and fro on the lateral frames between a first position and a second position;
at least one longitudinal bar connected to the crossbar so that they are movable together; and
at least two extensible elements connected to the longitudinal bar so that they are movable together; and
at least two vacuum chucks respectively connected to the extensible elements so that the extensible elements are operable to move the vacuum chucks between a lower position and an upper position;
wherein one of the vacuum chucks is located beyond the first end of the operative platform and the remaining one of the vacuum chucks is located above the operative platform when the crossbar is in the first position; and
wherein one of the vacuum chucks is located above the operative platform and the remaining one of the vacuum chucks is located beyond the second end of the operative platform when the crossbar is in the second position.

2. The conveyor according to claim 1, wherein the crane comprises:
two racks respectively supported on the lateral frames;
at least two cogs respectively engaged with the racks, wherein the cogs are connected to the crossbar; and
a motor operably connected to the cogs, wherein the motor is supported on the crossbar.

3. The conveyor according to claim 2, wherein the crane further comprises a reducer arranged between the motor and at least one of the cogs.

4. The conveyor according to claim 1, further comprising a pre-operation platform located at the first end of the operative platform.

5. The conveyor according to claim 1, further comprising an elevator located at the second end of the operative platform.

6. The conveyor according to claim 5, wherein the elevator comprises a fork for carrying a pallet.
